(19) United States
(12) Patent Application Publication
(10) Pub. No.: US 2006/0175791 A1
(43) Pub. Date: Aug. 10, 2006

(54) RUNNING BOARD LIFT ASSEMBLY

(75) Inventor: Staffan I. Kaempe, Paoli, IN (US)

Correspondence Address: HARTMAN & HARTMAN, P.C., 552 EAST 700 NORTH, VALPARAISO, IN, 46383, US

(73) Assignee: STARTRACKS LIFTS, INC., Valparaiso, IN (US)

(21) Appl. No.: 11/307,458

(22) Filed: Feb. 8, 2006

Related U.S. Application Data
(60) Provisional application No. 60/593,715, filed on Feb. 8, 2005.

(51) Int. Cl. B60R 3/00

(52) U.S. Cl. 280/166

(57) ABSTRACT

A lift assembly for mounting a running board on a vehicle and operational to raise and lower the running board. The lift assembly includes a support structure configured for mounting to the vehicle, a slide assembly slidably supported by the support structure for movement in a longitudinal direction of the lift assembly, arm assemblies pivotably supported by the support structure, and a device for moving the slide assembly relative to the support structure. The slide assembly includes followers that cam with camming members of each arm assembly. Each arm assembly further includes a shaft for supporting the running board. Each shaft is located on its arm assembly so as to move downward and upward when the arm assemblies are pivoted relative to the support structure as a result of the followers of the slide assembly camming against the camming members of the arm assemblies.

### CROSS REFERENCE TO RELATED APPLICATIONS

This application claims the benefit of U.S. Provisional Application No. 60/593,715, filed Feb. 8, 2005, the contents of which are incorporated herein by reference.

### BACKGROUND OF THE INVENTION

The present invention generally relates to apparatuses and equipment for assisting the movement of individuals and objects, and more particularly to a lift system adapted to raise and lower a running board of a motor vehicle, by which individuals can be assisted when entering and leaving the vehicle.

Running board lift systems have been commercially available in various configurations for use on motor vehicles. Such lift systems have generally been heavy and bulky, and therefore hard to install. In addition, existing lift systems typically significantly reduce ground clearance, often to the extent that they are unsuitable for installation in minivans and other similarly sized passenger vehicle. Even on full size vans and pickup trucks, ground clearance can be reduced to the extent that off-road operation of the vehicle can be hazardous. Another disadvantage of some existing lift systems is that their operation permits the running board to be lowered to the extent that the running board is forced downward against the surface on which the vehicle is parked, potentially causing the running board to raise the side of the vehicle.

In view of the above, there is a need for lift systems that can be installed on a vehicle to safely lift individuals and assist their entry and exiting the vehicle, without interfering with the operation, stability, and safety of the vehicle.

### BRIEF SUMMARY OF THE INVENTION

The present invention provides a lift assembly for mounting a running board on a motor vehicle and operational to raise and lower the running board relative to the vehicle. The lift assembly includes support means configured for mounting to the vehicle so as to be spaced above a surface on which the vehicle rests, a slide assembly slidably supported by the support means for movement in oppositely-disposed first and second directions parallel to a longitudinal direction of the lift assembly, first and second arm assemblies pivotably supported by the support means, and means for moving the slide assembly in the first and second directions thereof. The slide assembly comprises first and second follower means and the first and second arm assemblies comprise first and second means for camming with the first and second follower means respectively. The first and second arm assemblies further comprise first and second shafts approximately transverse to the longitudinal direction of the lift assembly. The first and second shafts are located on the first and second arm assemblies so as to move in downward and upward directions relative to the support means when the lift assembly is mounted to the vehicle and the first and second arm assemblies are pivoted in first and second rotational directions, respectively, relative to the support means as a result of the first and second follower means of the slide assembly camming against the first and second camming means of the first and second arm assemblies. By moving the slide assembly in the first and second directions thereof, the moving means causes the first and second follower means of the slide assembly to cam against the first and second camming means of the first and second arm assemblies and thereby lower and raise the first and second shafts, respectively.

According to the invention, the lift assembly can be significantly less bulky and weigh less than conventional running board lift systems so as to have minimal impact on the operation and stability of a vehicle to which the lift assembly is mounted, yet can safely lift individuals to assist their entering and exiting the vehicle. The lift assembly can be entirely mounted to the underside of the vehicle without any major intrusion to the vehicle structure, for example, with only the need to route electrical wiring through the vehicle body.

In addition to compactness, another advantage of the invention is that the assembly can be operated with relatively low input forces yet capable of lifting considerable weight as a result of the capability for operating with a significant mechanical advantage. Additional advantages include the ability to support both ends of a running board to allow for load-carrying capability at the extremities of the board, and the ability to reliable maintain the running board substantially parallel to the horizontal plane of the vehicle (i.e., parallel to ground) throughout the operational motion of the lift assembly. According to a preferred aspect of the invention, the lift assembly is configured to allow the running board to be lowered under the force of gravity, such that the assembly does not “jack” the vehicle as do existing running board lift systems.

Other objects and advantages of this invention will be better appreciated from the following description.

### BRIEF DESCRIPTION OF THE DRAWINGS

FIG. 1 shows a running board mounted to a lift assembly in accordance with a preferred embodiment of the present invention.

FIG. 2 is an exploded view of the lift assembly of FIG. 1.

FIG. 3 is a perspective view of the topside of the lift assembly of FIG. 1 in a raised position.

FIG. 4 is a bottom view of the lift assembly of FIG. 1.

FIG. 5 is a perspective view of the topside of the lift assembly of FIG. 1 in a lowered position.

FIG. 6 is a detailed perspective view of a liftarm assembly of the lift assembly of FIG. 5.

FIGS. 7 and 8 diagrammatically illustrate the mechanical advantage that can be obtained with the lift assembly of FIG. 1.

FIG. 9 is an isolated perspective view of the underside of a preferred rail assembly for the lift assembly of FIG. 1.

FIG. 10 is an exploded view of the rail assembly of FIG. 9.

FIG. 11 is an isolated perspective view of a preferred slide assembly for the lift assembly of FIG. 1.

FIG. 12 is an isolated frontal view of the slide assembly of FIG. 11.

FIG. 13 is an isolated perspective view of a preferred liftarm assembly for the lift assembly of FIG. 1.

FIG. 14 is an exploded view of the liftarm assembly of FIG. 13.

### DETAILED DESCRIPTION OF THE INVENTION

A running board lift assembly 14 of the present invention is shown in FIG. 1 with a running board 12 mounted to a pair of support shafts 1 8 that extend transversely to a longitudinal direction of the assembly 14. The assembly 14 is configured to be mounted near a lateral edge of a motor vehicle 10, particularly vehicles that are difficult to enter and exit by persons with limited mobility. However, it is foreseeable that the lift assembly 14 of this invention could find use in a variety of other locations and applications. The assembly 14 is shown mounted beneath the vehicle 10 and spaced above the surface 54 on which the vehicle 10 is resting.

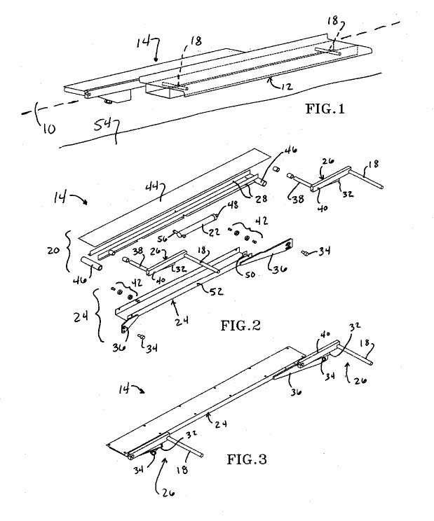

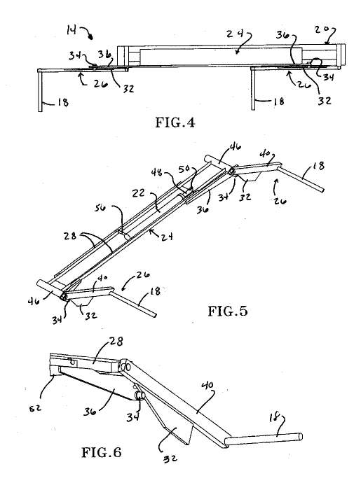

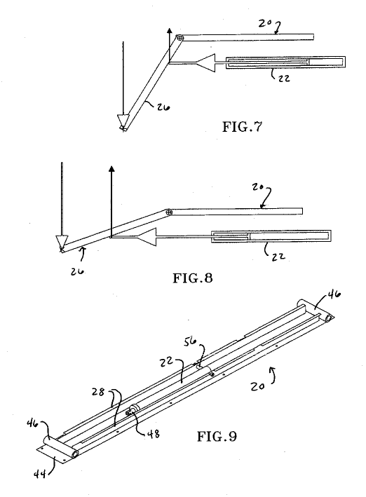

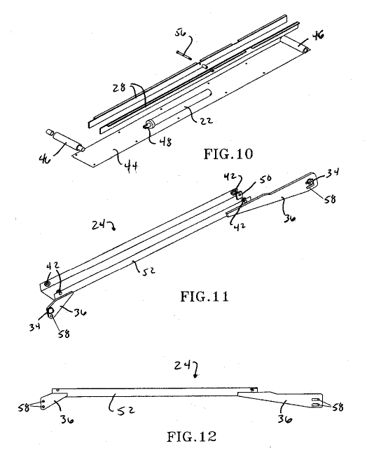

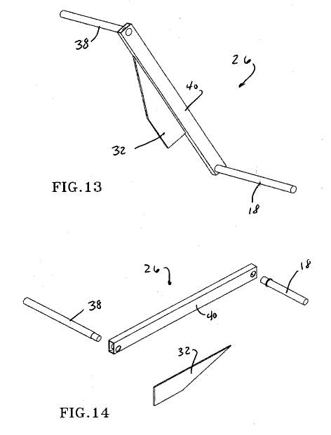

FIG. 2 is an exploded view of the components of the lift assembly 14, which is denoted as generally comprising a rail assembly 20 to which a cylinder 22 is mounted, a slide assembly 24 slidably mounted to the rail assembly 20 with roller assemblies 42, and two liftarm assemblies 26 pivotably coupled to the rail assembly 20. The liftarm assemblies 26 (shown in isolation in FIGS. 13 and 14) comprise the support shafts 18 that support the running board 12 as shown in FIG. 1. The rail assembly 20 (shown in isolation in FIGS. 9 and 10) includes a mounting plate 44 by which the lift assembly 14 can be mounted to the underside of the vehicle 10, such as with bolts (not shown). The rail assembly 20 also comprises two rails 28, each with a horizontal flange on which the roller assemblies 42 travel to support the slide assembly 24 for movement along the length of the rail assembly 20. The slide assembly 24 (shown in isolation in FIGS. 11 and 12) preferably comprises an elongate slide body 52 and a pair of holders 36 mounted at oppositely-disposed ends of the body 52. Each holder 36 is formed to have multiple openings 58 in which a roller 34 can be mounted to adjust the maximum elevation of the running board 12 relative to the vehicle 10.

The rails 28 are shown as being joined together at their ends by tubes 46, which receive pivot shafts 38 of the liftarm assemblies 26 and thereby pivotably couple the liftarm assemblies 26 to the rail assembly 20. The support and pivot shafts 18 and 38 of each liftarm assembly 26 are mounted to a liftarm tube 40 so as to be substantially parallel to each other and transverse to the longitudinal direction of the lift assembly 14. Because the pivot shafts 38 define the pivot axes of the liftarm assemblies 26, the tubes 40 radially space the support arms 18 from the pivot axes of the liftarm assemblies 26. Along the lower edge of each tube 40, a wedge 32 is formed or attached whose width increases with increasing radial distance from the pivot axis of its liftarm assembly 26. Raising and lowering of the liftarm assemblies 26 are through the interaction of the wedges 32 of the liftarm assemblies 26 with the rollers 34 mounted to the holders 36 at opposite ends of the slide assembly 24. As seen in FIG. 6, the wedges 32 define camming profiles that cam with the rollers 34 of the slide assembly 24, thereby causing the raising and lowering of the support shafts 18 and therefore raising and lower of the running board 12 mounted to the support shafts 18. According to a preferred aspect of the invention, the wedges 32 rest on their respective rollers 34, such that the liftarm assemblies 24 are lowered under the force of gravity as the rollers 34 cam down the slopes of their respective wedges 32.

The cylinder 22 is preferably operated hydraulically, though other actuating means are within the scope of this invention. A preferred cylinder is disclosed in U.S. Pat. No. 6,152,715 to Kaempe et al., the contents of which relating to the construction and operation of the cylinder 22 are incorporated herein by reference. One end of the cylinder 22 is secured to the rails 28 (e.g., near midlength thereof) with a pin 56, and has a piston rod 48 secured to a rod bracket 50 near one end of the slide assembly 24. In this manner, the cylinder 22 is operable to push and pull the slide assembly 24 in the longitudinal direction of the rail assembly 20. A hydraulic power unit (not shown) for operating the cylinder 22 can be installed beneath the vehicle 10 alongside the lift assembly 14, or any other place of convenience. The hydraulic power unit, and therefore the operation of the cylinder 22 and the entire lift assembly 14, can be electrically controlled with controls located anywhere of convenience, including the interior and exterior of the vehicle 10, as well as with a remote control unit.

FIG. 3 shows the cylinder 22 fully extended, such that the slide assembly 24 is positioned relative to the rail assembly 20 so that the wedges 32 of the liftarm assemblies 26 rest on the rollers 34 near the widest portions of the wedges 32, with the result that each liftarm assembly 26 is in a raised position. FIG. 5 shows the cylinder 22 fully retracted with the result that the liftarm assemblies 26 are in a lowered position. As such, movement of the slide assembly 24 by the cylinder 22 causes each roller 34 to cam against the lower edge of its corresponding wedge 32, causing both liftarm assemblies 26 to raise or lower depending on the direction of movement of the slide assembly 24 relative to the rail assembly 20. Because the arm assemblies 26 rotate upward as the cylinder is extended, the cylinder 22 actuates the rollers 34 along the camming profiles of the wedges 32 with an attack angle that decreases over the cylinder stroke, producing an increasing vertical force as the load moment arm increases to compensate for increasing load. This mechanical advantage is illustrated in FIGS. 7 and 8, which show that the upward force Fc on the running board increases with increasing stroke of the cylinder 22. The angles defined by the camming profiles of the wedges 32 determine the maximum and minimum mechanical advantage of the lift assembly 14, and therefore should be adapted for the expected loads of the particular application.

In view of the above, the lifting assembly 14 of the present invention operates on the basis of a mechanical lifting mechanism based on a wedge-camming action that provides a low profile and maintains low actuating forces. The result is a lift assembly 14 that can be significantly less bulky and weigh less than conventional running board lift systems, so as to have minimal impact on the operation and stability of a vehicle to which it is mounted, yet safely lift individuals to assist their entry and exiting the vehicle. In one embodiment of the invention, the lift assembly 14 weighs about 50 pounds (about 23 kg) without the running board 12 and has a vertical profile of only about 4.5 inches (about 11 cm).

While the invention has been described in terms of a specific embodiment, it is apparent that other forms could be adopted by one skilled in the art. For example, the geometry of the components could be modified to adapt the lift assembly 14 for lifting greater or lesser loads or for installation on particular vehicles. As such, lift assemblies within the scope of this invention could differ in appearance and construction from the embodiment shown in the Figures. Furthermore, the various generally conventional components such as rollers, bearings, bushings, fasteners, etc. described and/or shown in the Figures could be replaced by functionally-equivalent structures to achieve the functions desired for these components. Finally, the individual components of the lift assembly 14 could be formed of a variety of materials. Therefore, the scope of the invention is to be limited only by the following claims.

What is claimed is:

1. A lift assembly for mounting a running board on a motor vehicle and operational to raise and lower the running board relative to the vehicle, the lift assembly comprising:
support means configured for mounting to the vehicle so as to be spaced above a surface on which the vehicle rests;
a slide assembly slidably supported by the support means for movement in oppositely-disposed first and second directions parallel to a longitudinal direction of the lift assembly, the slide assembly comprising first and second follower means;
first and second arm assemblies pivotably supported by the support means, the first and second arm assemblies comprising first and second means for camming with the first and second follower means, respectively, and first and second shafts approximately transverse to the longitudinal direction of the lift assembly, the first and second shafts being located on the first and second arm assemblies so as to move in downward and upward directions relative to the support means when the lift assembly is mounted to the vehicle and the first and second arm assemblies are pivoted in first and second rotational directions, respectively, relative to the support means, as a result of the first and second follower means of the slide assembly camming against the first and second camming means of the first and second arm assemblies; and
means for moving the slide assembly in the first and second directions thereof, to cause the first and second follower means of the slide assembly to cam against the first and second camming means of the first and second arm assemblies and thereby lower and raise the first and second shafts, respectively.

2. The lift assembly according to claim 1, wherein the support means comprises at least one rail oriented in the longitudinal direction of the lift assembly, and the slide assembly comprises rollers engaged with the rail so as to support the slide assembly from the rail.

3. The lift assembly according to claim 2, wherein the slide assembly comprises an elongate member parallel to the rail of the support means, and the first and second follower means of the slide assembly are mounted at oppositely-disposed ends of the elongate member.

4. The lift assembly according to claim 1, wherein the first and second arm assemblies are pivotably supported by the support means so as to define pivot axes therewith, and the first and second shafts are radially spaced from the pivot axes of the first and second arm assemblies, respectively.

5. The lift assembly according to claim 4, wherein the first and second follower means comprise rollers and the camming means comprise wedge-shaped profiles defined by the first and second arm assemblies.

6. The lift assembly according to claim 5, wherein the wedge-shaped profiles increase in width in a radial direction away from the pivot axes of the first and second arm assemblies.

7. The lift assembly according to claim 5, wherein the slide assembly comprises multiple means for mounting the rollers.

8. The lift assembly according to claim 1, further comprising the running board mounted to the first and second shafts.

9. The lift assembly according to claim 6, further comprising means for preventing the running board from lifting the vehicle if the running board contacts the surface beneath the vehicle.

10. The lift assembly according to claim 9, wherein the preventing means comprises the first and second follower means of the slide assembly and the first and second camming means of the first and second arm assemblies as a result of the first and second camming means resting on but not otherwise being coupled with the first and second follower means.

11. The lift assembly according to claim 8, wherein the running board has oppositely-disposed ends supported by the shafts.

12. The lift assembly according to claim 8, wherein the lift assembly maintains the running board substantially parallel to the surface beneath the vehicle during raising and lowering the shafts.

13. The lift assembly according to claim 1, wherein the moving means comprises a hydraulic cylinder mounted to the support means.

14. The lift assembly according to claim 1, wherein the lift assembly is mounted to the vehicle.

15. The lift assembly according to claim 14, wherein the support means, the slide assembly, the first and second arm assemblies, and the moving means are entirely located on the exterior of the vehicle.

16. The lift assembly according to claim 1, wherein the lift assembly weighs not more than about 23 kilograms.

17. The lift assembly according to claim 1, wherein the lift assembly has a vertical profile of not more than about 11 cm when the first and second shafts are fully moved in the upward direction relative to the support means.

18. A running board lift assembly mounted to a motor vehicle, the running board lift assembly comprising:
support means mounted to the vehicle so as to be spaced above a surface on which the vehicle rests, the support means comprising at least one rail oriented in a longitudinal direction of the lift assembly;
a slide assembly slidably supported by the rail of the support means for movement in oppositely-disposed first and second directions parallel to the longitudinal direction of the lift assembly, the slide assembly comprising an elongate member and first and second follower means disposed at oppositely-disposed ends of the elongate member;
first and second arm assemblies pivotably supported by the support means so as to define pivot axes therewith, the first and second arm assemblies comprising first and second means for camming with the first and second follower means, respectively, and first and second shafts approximately transverse to the longitudinal direction of the lift assembly, the first and second shafts being radially spaced from the pivot axes of the first and second arm assemblies, respectively, so as to move in downward and upward directions relative to the support means when the first and second arm assemblies are pivoted in first and second rotational directions, respectively, relative to the support means as a result of the first and second follower means of the slide assembly camming against the first and second camming means of the first and second arm assemblies;
a running board supported by the first and second shafts; and
means for moving the slide assembly in the first and second directions thereof, to cause the first and second follower means of the slide assembly to cam against the first and second camming means of the first and second arm assemblies and thereby lower and raise the first and second shafts, respectively.

19. The running board lift assembly according to claim 18, wherein the camming means comprise wedge-shaped profiles between the pivot axes and the first and second shafts of the first and second arm assemblies, the wedge-shaped profiles increasing in width in a radial direction away from the pivot axes of the first and second arm assemblies.

20. The running board lift assembly according to claim 18, wherein the first and second camming means of the first and second arm assemblies rest on but are not otherwise coupled with the first and second follower means of the slide assembly.
